(19) United States
(12) Patent Application Publication
(10) Pub. No.: US 2013/0091805 A1
(43) Pub. Date: Apr. 18, 2013

(54) SYSTEM AND METHOD FOR CURING, STERILIZATION AND ASEPTIC PACKAGING OF MEDICAL DEVICES

(71) Applicant: R. Alastair Winn, Santa Barbara, CA (US)

(72) Inventor: R. Alastair Winn, Santa Barbara, CA (US)

(73) Assignee: APPLIED SILICONE CORPORATION, Santa Paula, CA (US)

(21) Appl. No.: 13/274,205

(22) Filed: Oct. 14, 2011

(51) Int. Cl. B65B 55/02; B29C 35/08

(52) U.S. Cl. 53/425; 425/174.4

(57) ABSTRACT

The present invention provides a system and method for curing, sterilization and aseptic packaging of products, especially medical devices, in a single unit. The process is streamlined with an aseptic packaging step eliminating the need for a second sterilization cycle following packaging. The ability to sterilize and cure products in a dry heat sealed autoclave tube prior to packaging, transfer the products in a sterile airtight environment to the packaging chamber, and to place the products into packages in an aseptic chamber prevents recontamination of the products during packaging and results in a savings of time, product, and packaging expenses.

### BACKGROUND

The present invention is directed to the art of packaging medical devices. Many medical devices, such as breast prosthetic implants, are cured using a heat curing process.

Silicone medical devices, in particular, are typically manufactured in non-sterile environments and subsequently packaged and sterilized using various means, such as gamma radiation, ethylene oxide, steam, ozone, and the like. However, various methods of sterilization may be contraindicated depending on the type of product being manufactured, or the particular silicone used to form the product. For example, high energy radiation is usually not suitable for silicone gel filled breast implants due to radiation induced crosslinking of the gel. Ethylene oxide is also not usually used because silicone gel absorbs the ethylene oxide, requiring long de-aeration cycles. Ethylene oxide is also not environmentally friendly.

Steam sterilization is also not typically used because of the difficulty in ensuring sterilization of products having thick sections. Ozone is suitable for surface sterilization, but is less efficient that ethylene oxide. Dry heat, on the other hand, is preferable, but the packaging of the products must be designed to accommodate high temperatures and the thermal expansion of the products caused by those temperatures.

There are silicone medical devices, such as breast implants, where curing of the silicone prior to packaging and ultimate sterilization of the packed product is required. When the curing process is carried out at sufficient temperature and time, the devices are rendered sterile. The sterile devices are then typically removed from the curing machine or oven and transferred in a non-sterile state to a packaging machine where the devices are packaged, typically using a sealed container such as a pouch or thermoform or similar method. The packaged device is then subjected to a sterilization process to sterilize the device and package. This process is inefficient and results in increased expense and product loss due to having to re-sterilize the medical device once it has been packaged.

Traditional processes used by major medical device companies rely upon an expensive heat resistant blister pack and a greater than 24 hour at 130 degrees centigrade dry heat sterilization cycle. Given recontamination during packaging, an expensive post-packaging sterilization cycle seems necessary and yet is redundant since the product being packaged was rendered sterile through processing prior to packaging.

A need therefore exists for a system and method for aseptically transferring an already sterile device to a packaging process that is also performed under aseptic conditions so as to prevent recontamination of the sterile device during packaging. Such a system and method will be capable of handling high volume manufacture of the devices while allowing for transfer and packaging in sterile conditions that decrease expense and prevent unnecessary losses of product due to recontamination or unnecessary handling. The present invention solves these and other needs.

### SUMMARY OF THE INVENTION

The present invention provides a system and method for sterilizing and packaging in a streamlined process for improving the packaging efficiency of aseptic products. Medical devices, in particular, are one example of a class of products for which the present invention is especially useful given their need for sterilization and curing, their disposable nature or single-use feature, and the consequent high volume of production.

In its most general aspect, the system and method of the present invention provides for transferring and packaging medical products in a manner which maintains the products in a sterile state.

In one aspect of the present invention, unvulcanized (uncured) medical devices, such as breast implants, are placed within a hermetically sealable carrier that is capable of withstanding temperatures sufficient to cure and dry heat sterilize the material forming the medical device. After the medical devices are cured and sterilized, the sealable carrier is transferred from the heating apparatus used to provide the heat necessary to cure the medical devices to an aseptic packaging device for final packaging. In one alternative embodiment, the sealable carrier is configured to aseptically couple with a load lock or similar system of the packaging apparatus, allowing the cured and sterile medical device to be aseptically transferred out of the sealable carrier and into the packaging device where the device is then packaged under aseptic conditions. The packaged device is then removed from the packaging apparatus through the same, or another, load lock.

Within the aseptic packaging chamber is a packaging device. In one aspect, presterilized products are inserted and sealed in presterilized packages. In an alternative aspect, the packaging device may include a blister form and seal device.

In still another aspect, the present invention includes a system for curing, sterilizing and aseptically packaging medical devices, comprising: a sealable carrier configured to hold a device during curing of the device, the carrier designed to withstand heat for a prolonged period of time to provide for curing and sterilization of the device; an aseptic chamber, the aseptic chamber isolated from the environment by at least one lock, the lock configured to mate with the carrier to provide an aseptic pathway from the carrier into the chamber; and a packaging device disposed within the chamber for packing the device in an aseptic manner. In an alternative aspect, the aseptic chamber and the packaging device therein are configured such that the medical device can be placed into a package and sealed by the packaging device. In another aspect, the aseptic carrier includes a jacket that is configured to receive steam to heat an interior of the aseptic carrier to cure and sterilize the implantable silicone gel filled breast implant. In still another aspect, the aseptic carrier includes a jacket that is configured to be cooled by a cooling fluid or gas so as to cool the cured, sterilized implantable silicone gel filled breast implant. In still another aspect, the jacket is configured to be heated and cooled. In another aspect, the packaging device is a blister form and seal device.

In still another aspect, the medical device is a breast implant, and in still another aspect, the breast implant is formed from silicone.

In a further aspect, the package includes a thermoformed seal. In a still further aspect, the package includes two layers.

In still another aspect, the packaging device includes at least one apparatus for thermoforming a package blister, and in an alternative aspect, the at least one apparatus for thermoforming a includes at least one element selected from the group of elements consisting of: an infrared lamp, a die cutter, a plastic feed roll, a piston to drive suction, and an air cylinder.

In yet another aspect, the present invention includes a method for curing, sterilizing and aseptically packaging medical products, comprising: inserting a product to be cured and sterilized into a sealable carrier; hermetically sealing the carrier; applying heat to the sealed carrier to cure and sterilize the product; aseptically transferring the cured and sterilized product from the carrier into a an aseptic packaging chamber; placing the cured and sterilized product within the aseptic chamber in a sterile package, sealing the cured and sterilized product within the sterile package; and removing the sealed, sterile package containing the cured and sterilized product from the aseptic packaging chamber in a manner that maintains the aseptic packaging chamber in an aseptic condition. In another aspect, applying heat to the sealable carrier includes heating the carrier to a temperature in the range of 150 to 170 degrees centigrade for a period of 5 to 7 hours. In still another aspect, the package is a blister form and seal package.

In a further aspect, the present invention includes a method of sterilizing silicone medical devices comprising: sterilizing an unpackaged device using elevated temperature in an aseptic environment; packaging the device in an aseptic environment; and removing the packaged device from the aseptic environment.

In still another further aspect, the present invention includes a method of sterilizing silicone medical devices, comprising: curing and sterilizing an unpackaged device by heating the unpackaged device at an elevated temperature in an aseptic sealed environment; packaging the cured, sterile device in an aseptic environment; and removing the packaged device from the aseptic environment.

In yet another aspect, the present invention includes a method of sterilizing silicone medical devices, comprising: sterilizing an unpackaged device by heating the unpackaged device at an elevated temperature in an aseptic sealed carrier; aseptically transferring the sterile device to an aseptic environment; packaging the sterile device in the aseptic environment; and removing the packaged device from the aseptic environment.

In another aspect, the present invention includes a method of sterilizing implantable silicone breast implants, comprising: sterilizing an unpackaged implantable silicone breast implant by heating the unpackaged implantable silicone breast implant at an elevated temperature in an aseptic sealed carrier; aseptically transferring the sterile unpackaged implantable silicone breast implant to an aseptic environment; packaging the sterile unpackaged implantable silicone breast implant in the aseptic environment; and removing the packaged sterile implantable silicone breast implant from the aseptic environment.

In yet another aspect, the present invention includes a method of sterilizing an implantable silicone gel filled breast implant, comprising: sterilizing an unpackaged implantable silicone gel filled breast implant by heating the unpackaged implantable silicone gel filled breast implant at an elevated temperature in an aseptic sealed carrier; aseptically transferring the sterile unpackaged implantable silicone gel filled breast implant to an aseptic environment; packaging the sterile unpackaged implantable silicone gel filled breast implant in the aseptic environment; and removing the packaged sterile implantable silicone gel filled breast implant from the aseptic environment.

In another aspect, the present invention includes a method of sterilizing implantable silicone gel filled breast implants, comprising: curing the silicone gel and sterilizing the implantable silicone gel filled breast implant by heating at an elevated temperature in an aseptic sealed carrier; aseptically transferring the sterile implantable silicone gel filled breast implant in the aseptic sealed carrier to an aseptic chamber; packaging the sterile implantable silicone gel filled breast implant in the aseptic chamber; and removing the packaged sterile implantable silicone gel filled breast implant from the aseptic chamber. In an alternative aspect, the aseptic sealed carrier is configured to be reversibly disconnected from the aseptic chamber.

In still another aspect, aseptically transferring the sealed carrier containing the sterile implantable silicone gel filled breast implant to an aseptic chamber includes connecting the sealed carrier to an entry port of seal area in communication with the aseptic chamber, the entry port and seal area forming a space lock, the space lock capable of being sterilized before the sealed carrier is connected to the entry lock. In a further aspect, the space lock between the aseptic chamber and the sealed carrier is sterilized by steam autoclaving.

In an alternative aspect the space lock between the aseptic chamber and the sealed carrier is sterilized by ozone exposure at a temperature greater than 30 degrees centigrade. In another aspect, the temperature is 50 degrees centigrade. In still another aspect, the space lock between the aseptic chamber and the sealed carrier is sterilized using ethylene oxide. In still another alternative aspect, the space lock between the aseptic chamber and the sealed carrier is sterilized using ethylene oxide.

In still another aspect, aseptically transferring the sealed carrier the sterile implantable silicone gel filled breast implant to an aseptic chamber includes connecting the sealed carrier to an entry port of seal area in communication with the aseptic chamber, the space lock and seal being capable of being ruptured so as to join the aseptic chamber and the sealed carrier.

In yet another aspect, packaging the sterile implantable silicone gel filled breast implant includes placing the sterile implantable silicone gel filled breast implant in a presterilized thermoform; and sealing the sterile implantable silicone gel filled breast implant in the presterilized thermoform before removing the packaged sterile implantable silicone gel filled breast implant from the aseptic chamber. In a further aspect, the invention includes thermoforming a package configured to receive the sterile implantable silicone gel filled breast implant within the aseptic chamber from presterilized thermoformable plastic sheeting; and sealing the thermoformed package containing the sterile implantable silicone gel filled breast implant before removing the packaged sterile implantable silicone gel filled breast implant from the aseptic chamber. In one aspect, thermoforming a package is accomplished using an apparatus including at least one element selected from the group of elements consisting of an infrared lamp, a die cutter, a plastic feed roll, a piston drive suction and an air cylinder.

In still another aspect, the aseptic carrier is configured to be steam heated. In an alternative aspect, the aseptic carrier includes a jacket that is configured to receive steam to heat an interior of the aseptic carrier to cure and sterilize the implantable silicone gel filled breast implant. In yet another alternative aspect, the aseptic carrier includes a jacket that is configured to be cooled by a cooling fluid or gas so as to cool the cured, sterilized implantable silicone gel filled breast implant.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a schematic view of the components of an aseptic packaging system in accordance with an embodiment of the present invention.

FIG. 2 is a top view of one embodiment of a carrier for transporting medical devices in accordance with principles of the present invention.

FIG. 3 is a side view of the carrier of FIG. 2 illustrating the placement of the medical devices within the sealable carrier.

FIG. 4 is a side view of an aseptic packaging chamber in accordance with one embodiment of the present invention showing the chamber and isolation load locks.

FIG. 5 is a side cut away view of an isolation lock as shown in FIG. 4.

FIG. 6 is a schematic diagram of the aseptic packaging chamber of FIG. 4 illustrating additional details including an embodiment of a vacuum heat sealing system for packing medical devices.

FIG. 7 is a schematic diagram of one embodiment of a vacuum heat sealing system.

### DETAILED DESCRIPTION OF THE PREFERRED EMBODIMENTS

In accordance with an aspect of the present invention, provided herein is a single system that cures, sterilizes and aseptically packages medical products. The system includes either fixed or removable carriers used during curing and sterilizing the medical devices or other products and then subsequently transporting the devices to an aseptic packaging machine to package the devices such that the devices are not re-contaminated during the packaging process.

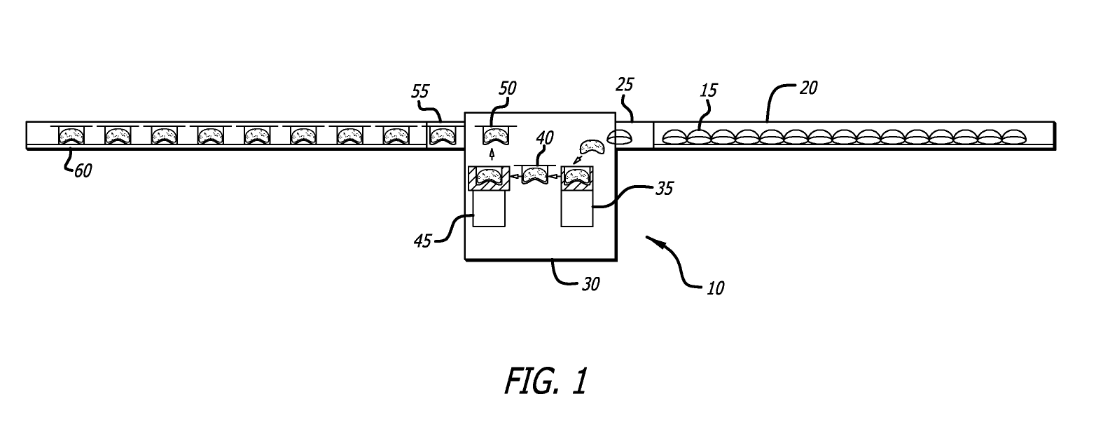

FIG. 1 is a schematic representation of a system 10 that is configured to provide for dry heat curing and sterilization of medical products 15, such as, for example, breast prostheses or implants. The medical products are placed into a carrier 20 which is sealable to isolate the contents of the chamber from the environment outside of the carrier. The carrier is constructed of a material designed for easy de-contamination, and which will also withstand the heating necessary for curing the medical devices within the carrier.

The carrier 20 is configured to mate with an isolation lock 25 in such a manner that the devices 15 may be transferred from the carrier 20 into a packing machine 30, the interior of which is sterile. The cooperation of the lock 25 and carrier 20 is such that the devices which have been rendered sterile during the curing process are transferred into the packing machine 30 in a sterile manner to prevent contamination of the medical devices. In one embodiment, the carrier includes a jacket configured to allow the medical devices inside the carrier to be cooled after the dry heat sterilization/cure cycle is completed. In another embodiment, the jacket may be configured to be used for both heating and cooling of the carrier, providing for increased efficiency in curing, sterilizing and cooling the contents of the carrier. In still another embodiment, the jacket may be used to cure and sterilize the contents of the carrier without then cooling the contents of the carrier.

In one embodiment of the packing machine of the present invention, the medical devices are packed in a two layer aseptic package. For example, device 15 is transferred from carrier 20 through lock 25 into the interior of packing machine 30 wherein the medical device is placed is first packaged within an inner package using a thermoform device 35. The device within the inner package 40 are then transferred to another thermoforming device 45 to form the outer package. Once the outer package is formed, the combination of medical device, inner package and outer package 50 are then transferred from the packaging machine 30 through lock 55 and onto a conveyor 60 to transport the device away from the packing machine 30 to, for example, a warehouse where the packaged, sterile medical device will be stored until shipped to a customer for use.

While the process has been described with reference to FIG. 1 as an integrated process, one skilled in the art will immediately understand that the machinery and process may be modified without departing from spirit of the invention. For example, the carrier 20 could take the form of a sealed chamber that is placed within a heater for heating the carrier/chamber to a desired temperature for curing and sterilizing the devices inside the carrier/chamber. The carrier/chamber would then be transported to the packing machine 30 where the devices would be aseptically transferred from the carrier/chamber through the lock 25 to the interior of the packaging machine.

Alternatively, the machinery could be arranged so that the carrier/chamber 20 is connected to the packaging machine, thus facilitating, using appropriate lock technology, a continuous system of curing, sterilizing and packaging the medical devices.

In still another embodiment, the thermoforming devices 35, 45 may be integrated into a single assembly for forming the two layers of the device packaging. In another embodiment, the device may be packaged within a single layer of packaging material.

Any packaging material known by those skilled in the art may be used to package the medical device. The only requirement is that the packaging material be capable of being thermoformed within an aseptic environment, and that the packaging material meet the requirements of the device designer for maintenance of the sterility of the device for the devices projected shelf life.

FIG. is a top view of one embodiment of a carrier or chamber 100 showing a plurality of devices to be cured and sterilized arranged in one possible arrangement upon the carrier. In this embodiment, a plurality of devices 105 may be simultaneously cured and sterilized, and then transported to a packaging machine for aseptic packaging as described above. Alternatively, the carrier may be configured to hold only a single row, or column, of devices to be cured and sterilized. Further, the carrier could be configured to hold only one device. In any of the above embodiments, or embodiments that may be conceived in accordance with the principles of the present invention, the carrier may be constructed of a re-usable material, such that the carrier may be used repeatedly, or the carrier may be designed to be used once, and then disposed of or recycled.

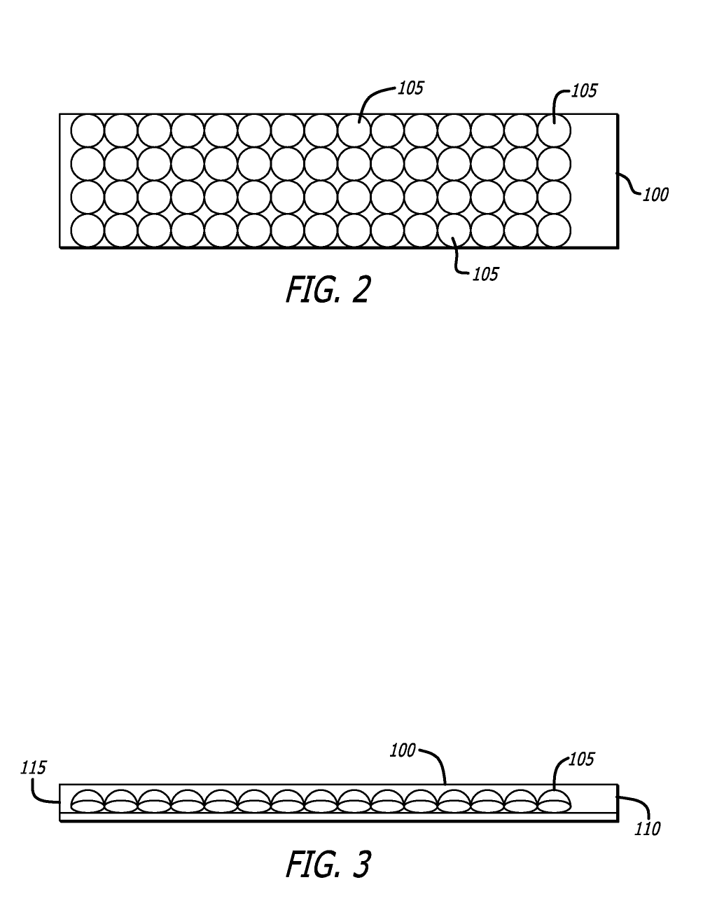

FIG. 3 depicts a side view of the carrier shown in FIG. 2. In this view, devices 105 are shown placed inside of the carrier 100, which has a seal 100 at one end and a second seal 115 at its opposite end. Seals 100, 114 may be formed in various manners. For example, the seals may be heat sealed, that is, the seals may be formed of a material that is capable of being thermally welded together to form a gas tight seal. Alternatively, seals 110 and 115 may be capable of being open and closed repeatedly to provide for a carrier that may be used more than once. Such seals would also be preferable in a system designed for continuous curing, sterilizing and packaging as described above.

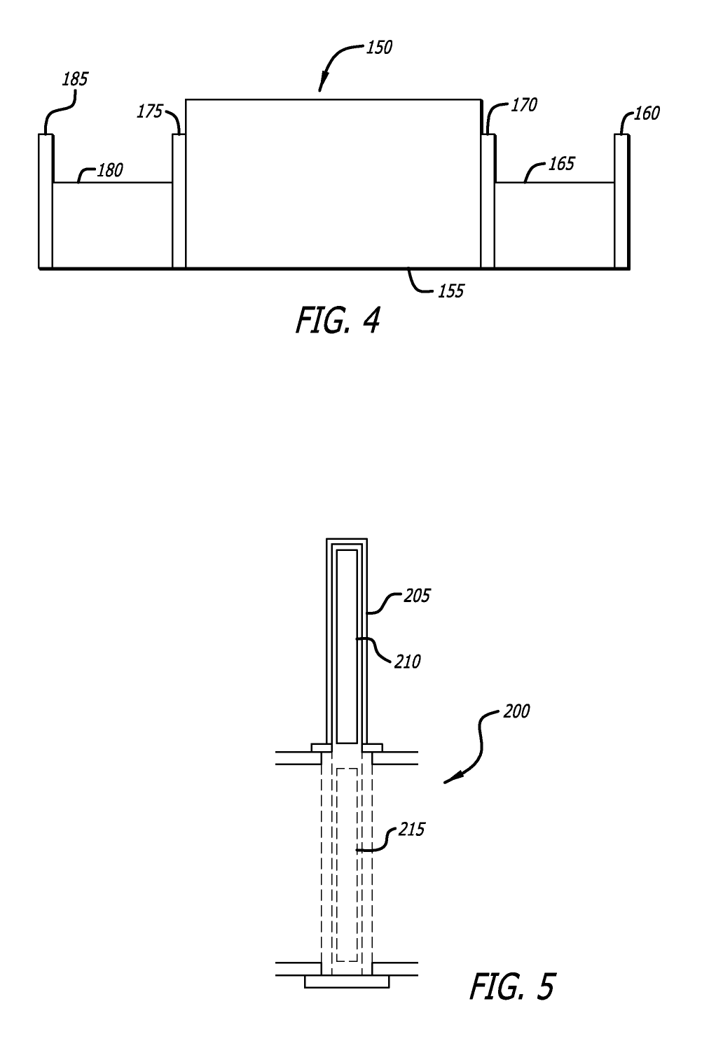

FIG. 4 illustrates one embodiment of an aseptic packaging chamber and lock assembly 150. In this embodiment, lock 160 is configured to receive a carrier 20. Lock 160 is then opened, and a cured, sterile device, is transferred from the carrier 20 through lock 160 into chamber 165. Lock 160 is then closed, and lock 170 is opened, allowing the device to be moved from chamber 165 into the interior of the packing machine 155 for packaging. Lock 170 is then closed, and the process is repeated to move the next device to be packaged into chamber 165.

Once the device is packaged, the device is moved through lock 175 into chamber 180. Lock 175 is then closed, maintaining the aseptic integrity of the packing machine 155, lock 185 is opened, and the device is removed from chamber 180 for further processing.

FIG. 5 illustrates details of the construction of one embodiment of an isolation lock 200. In this embodiment, the lock includes a housing 205 configured to allow a plate 210 to move upwards into the housing to open the lock to allow for transfer of devices through the lock. The plate may then be moved to a second position, identified in phantom by the reference numeral 215, to close the lock. Appropriate seals known to those skilled in the art are used to ensure that the lock, when closed, prevents transfer of contaminants from the environment into the interior of the packing machine. Other arrangements providing the locking function are known to those skilled in the art, and are intended to fall within the scope of the invention.

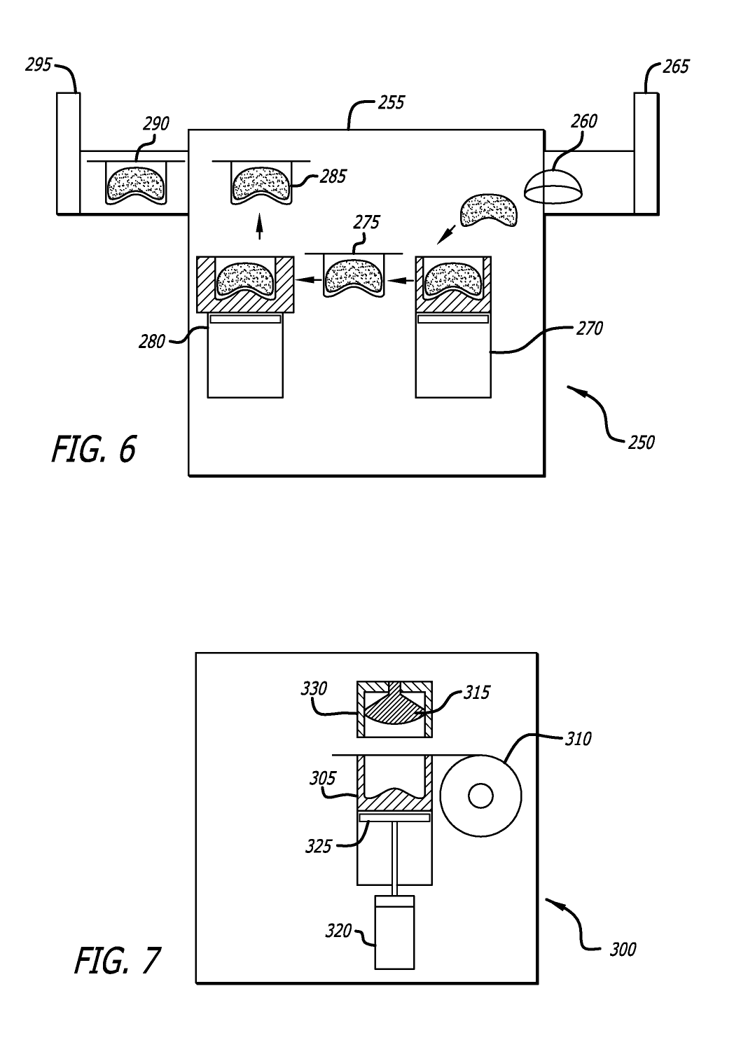

FIG. 6 is a schematic view of one embodiment of the packaging devices disposed within the interior of one exemplary packing machine 250. This embodiment illustrates a design using two thermoforming devices to provide and inner and an outer package for a cured, sterile medical device.

A device 260 is transported into the packaging chamber 255 through lock 265. Note, in this embodiment, only a single lock 265 is shown, in contrast to the lock arrangement of FIG. 4. Device 260 is then mounted on the inner thermoforming device 270, which perfects the inner packaging of the device. The now packaged device 275 is removed from thermoforming device 270 and mounted on outer thermoforming device 280 for perfection of the outer package of the device. After the outer package is thermoformed by device 280, the inner/outer packaged device 285 is transferred out of chamber 255 into chamber 290, and thence through 295 out of the aseptic packaging machine for further processing.

FIG. 7 is a schematic view of an exemplary thermoforming system 300. In this embodiment a roll of thermoformable material 310 is used to create a package. A lamp 315 is used to heat the material until it softens and is capable of deformation. An air cylinder 320 then draws piston 325 downwards, causing a vacuum to form within chamber 305. Once the inner cavity of the package is formed, the device is placed within the package, and then the material from roll 310 is used to form a top to the package, which is then heat sealed to the remainder of the package, and cut to size using a cutter 330.

In accordance with another aspect of the present invention, provided herein is a streamlined process that sterilizes and aseptically packages products, such as medical devices. The process involves curing the products in such a manner that they are sterilized during the curing cycle, and then transferring the cured, sterile products to a packaging device for aseptically packaging the devices without re-contaminating the device, thus avoiding a second sterilization step post packaging.

An exemplary process embodying principles of the present invention will be described with reference curing, sterilizing and packaging a silicone breast prosthesis. In this exemplary process, the packaging chamber is dry heat sterilized, typically at temperatures between 120 degrees centigrade and 160 degrees centigrade, then maintained in a aseptic condition for packaging the cured, sterile breast prostheses.

Breast prostheses are formed and then filled with a suitable gel, as is known in the art. The formed and filled prostheses are then placed into a carrier, which may be a dry autoclave, typically on a piece of suitable paper. The carrier is the closed and heated to between 120 and 170 degrees centigrade, and preferably at 160 degrees centigrade, for a suitable period of time, such as, for example 4 hours, or until the prostheses are cured and rendered sterile. In one embodiment, the carrier, which may be a dry autoclave, may be constantly purged with preheated sterile air at a rate of, for example, two liters per minute.

Once the curing/sterilization process is completed, the carrier may be cooled using an appropriate coolant, such as, for example, water, until the internal temperature of the carrier is less than a selected temperature, such as, for example, less than 50 degrees centigrade.

A packaging blister may be used to package the device. Such a blister will preferably be presterilized using gamma radiation, ethylene oxide or other suitable sterilant. The sterile packaging blister, typically bulk packaged in a biologically sealed container, are then transferred to a sterilizable lock connected to the packaging chamber, and the outer container is flash autoclaved, for example, for three minutes at 135 degrees centigrade to kill all external bioburden associated with the container holding the packing shells. The container can be opened after sterilization and passed into the sterile packaging chamber.

The space lock between the package transfer autoclave and the packaging chamber is opened and the packaging material is transferred into the packing chamber; the lock is then closed. The lock which has been mated to the carrier is now opened and the cured, sterilized devices are transferred into the packing chamber, and the lock is then closed, isolating the cured, sterilized breast prosthesis or prostheses in the packing chamber with the packing material.

Using either a robotic manipulator, or in the alternative, manually using known glove box techniques, a cured, sterilized breast prosthesis is placed into a packing shell and the inner package is sealed. The inner package is then placed into an outer package and the outer package is sealed. The double sealed product is then placed into the exit lock and removed for further processing. Those skilled in the art will understand that more than one breast prosthesis may be moved through each of the locks at a time to minimize cycling of the locks, and thus potential for inadvertent contamination of the packing chamber.

The present invention is not limited to the embodiments described above. Various changes and modifications can, of course, be made, without departing from the scope and spirit of the present invention. Additional advantages and modifications will readily occur to those skilled in the art. Accordingly, various modifications may be made without departing from the spirit or scope of the general inventive concept as defined by the appended claims and their equivalents.

I claim:

1. A system for curing, sterilizing and aseptically packaging medical devices, comprising:
a sealable carrier configured to hold a device during curing of the device, the carrier designed to withstand heat for a prolonged period of time to provide for curing and sterilization of the device;
an aseptic chamber, the aseptic chamber isolated from the environment by at least one lock, the lock configured to mate with the carrier to provide an aseptic pathway from the carrier into the chamber; and
a packaging device disposed within the chamber for packing the device in an aseptic manner.

2. The system of claim 1, wherein the aseptic chamber and the packaging device therein are configured such that the medical device can be placed into a package and sealed by the packaging device.

3. The system of claim 2, wherein the packaging device is a blister form and seal device.

4. The system of claim 1, wherein the medical device is a breast implant.

5. The system of claim 4, wherein the breast implant is formed from silicone.

6. The system of claim 2, wherein the package includes a thermoformed seal.

7. The system of claim 2, wherein the package includes two layers.

8. The system of claim 1, wherein the packaging device includes at least one apparatus for thermoforming a seal.

9. The system of claim 8, wherein the at least one apparatus for thermoforming a seal includes at least one element selected from the group of elements consisting of: an infrared lamp, a die cutter, a plastic feed roll, a piston to drive suction, and an air cylinder.

10. A method for curing, sterilizing and aseptically packaging medical products, comprising:
inserting a product to be cured and sterilized into a sealable carrier;
hermetically sealing the carrier;
applying heat to the sealed carrier to cure and sterilize the product;
aseptically transferring the cured and sterilized product from the carrier into a an aseptic packaging chamber;
placing the cured and sterilized product within the aseptic chamber in a sterile package;
sealing the cured and sterilized product within the sterile package; and
removing the sealed, sterile package containing the cured and sterilized product from the aseptic packaging chamber in a manner that maintains the aseptic packaging chamber in an aseptic condition.

11. The method of claim 10, wherein applying heat to the sealable carrier includes heating the carrier to a temperature in the range of 150 to 170 degrees centigrade for a period of 5 to 7 hours.

12. The method of claim 10, wherein the package is a blister form and seal package.

13. A method of sterilizing silicone medical devices comprising:
sterilizing an unpackaged device using elevated temperature in an aseptic environment;
packaging the device in an aseptic environment; and
removing the packaged device from the aseptic environment.

14. A method of sterilizing silicone medical devices, comprising:
curing and sterilizing an unpackaged device by heating the unpackaged device at an elevated temperature in an aseptic sealed environment;
packaging the cured, sterile device in an aseptic environment; and
removing the packaged device from the aseptic environment.

15. A method of sterilizing silicone medical devices, comprising:
sterilizing an unpackaged device by heating the unpackaged device at an elevated temperature in an aseptic sealed carrier;
aseptically transferring the sterile device to an aseptic environment;
packaging the sterile device in the aseptic environment; and
removing the packaged device from the aseptic environment.

16. A method of sterilizing implantable silicone breast implants, comprising:
sterilizing an unpackaged implantable silicone breast implant by heating the unpackaged implantable silicone breast implant at an elevated temperature in an aseptic sealed carrier;
aseptically transferring the sterile unpackaged implantable silicone breast implant to an aseptic environment;
packaging the sterile unpackaged implantable silicone breast implant in the aseptic environment; and
removing the packaged sterile implantable silicone breast implant from the aseptic environment.

17. A method of sterilizing an implantable silicone gel filled breast implant, comprising:
sterilizing an unpackaged implantable silicone gel filled breast implant by heating the unpackaged implantable silicone gel filled breast implant at an elevated temperature in an aseptic sealed carrier;
aseptically transferring the sterile unpackaged implantable silicone gel filled breast implant to an aseptic environment;
packaging the sterile unpackaged implantable silicone gel filled breast implant in the aseptic environment; and
removing the packaged sterile implantable silicone gel filled breast implant from the aseptic environment.

18. A method of sterilizing implantable silicone gel filled breast implants, comprising:
curing the silicone gel and sterilizing the implantable silicone gel filled breast implant by heating at an elevated temperature in an aseptic sealed carrier;
aseptically transferring the sterile implantable silicone gel filled breast implant to an aseptic chamber;
packaging the sterile implantable silicone gel filled breast implant in the aseptic chamber; and
removing the packaged sterile implantable silicone gel filled breast implant from the aseptic chamber.

19. The method of claim 18, wherein the aseptic sealed carrier is configured to be reversibly disconnected from the aseptic chamber.

20. The method of claim 19, wherein aseptically transferring the sealed carrier the sterile implantable silicone gel filled breast implant to an aseptic chamber includes connecting the sealed carrier to an entry port of seal area in communication with the aseptic chamber, the entry port and seal area forming a space lock, the space lock capable of being sterilized before the sealed carrier is connected to the entry lock.

21. The method of claim 20, further comprising sterilizing the space lock between the aseptic chamber and the sealed carrier by steam autoclaving.

22. The method of claim 20, further comprising sterilizing the space lock between the aseptic chamber and the sealed carrier by ozone exposure at a temperature greater than 30 degrees centigrade.

23. The method of claim 22, wherein the temperature is 50 degrees centigrade.

24. The method of claim 20, further comprising sterilizing the space lock between the aseptic chamber and the sealed carrier using ethylene oxide.

25. The method of claim 19, wherein aseptically transferring the sealed carrier the sterile implantable silicone gel filled breast implant to an aseptic chamber includes connecting the sealed carrier to an entry port of seal area in communication with the aseptic chamber, the space lock and seal being capable of being ruptured so as to join the aseptic chamber and the sealed carrier.

26. The method claim 18, wherein packaging the sterile implantable silicone gel filled breast implant includes placing the sterile implantable silicone gel filled breast implant in a presterilized thermoform; and
sealing the sterile implantable silicone gel filled breast implant in the presterilized thermoform before removing the packaged sterile implantable silicone gel filled breast implant from the aseptic chamber.

27. The method claim 18, further comprising:
thermoforming a package configured to receive the sterile implantable silicone gel filled breast implant within the aseptic chamber from presterilized thermoformable plastic sheeting; and
sealing the thermoformed package containing the sterile implantable silicone gel filled breast implant before removing the packaged sterile implantable silicone gel filled breast implant from the aseptic chamber.

28. The method of claim 27, wherein thermoforming a package is accomplished using an apparatus including at least one element selected from the group of elements consisting of an infrared lamp, a die cutter, a plastic feed roll, a piston drive suction and an air cylinder.

29. The method of claim 18, wherein the aseptic carrier is configured to be steam heated.

30. The method of claim 18, wherein the aseptic carrier includes a jacket that is configured to receive steam to heat an interior of the aseptic carrier to cure and sterilize the implantable silicone gel filled breast implant.

31. The method of claim 18, wherein the aseptic carrier includes a jacket that is configured to be cooled by a cooling fluid or gas so as to cool the cured, sterilized implantable silicone gel filled breast implant.
